(19) United States
(12) Patent Application Publication
(10) Pub. No.: US 2014/0193161 A1
(43) Pub. Date: Jul. 10, 2014

(54) Enabling Communication Between Two End Terminals in a Fibre Optic Network

(71) Applicants: Einar In De Betou, Vällingby (SE); Stefan Dahlfort, Stockholm (SE); David Hood, Palo Alto, CA (US); Peter Öhlén, Stockholm (SE)

(72) Inventors: Einar In De Betou, Vällingby (SE); Stefan Dahlfort, Stockholm (SE); David Hood, Palo Alto, CA (US); Peter Öhlén, Stockholm (SE)

(73) Assignee: TELEFONAKTIEBOLAGET L M ERICSSON (PUBL), Stockholm (SE)

(21) Appl. No.: 14/117,473

(22) PCT Filed: May 17, 2011
(86) PCT No.: PCT/SE11/50620

§ 371 Date: Nov. 13, 2013

(51) Int. Cl. H04L 7/02; H04B 10/27

(52) U.S. Cl. CPC H04L 7/02; H04B 10/27
USPC 398/154

(57) ABSTRACT

A first end terminal and a second end terminal, as well as a respective method therein, are provided for enabling communication between the first end terminal and the second end terminal in a fibre optic access network. When the first and the second end terminal wish to communicate with each other, they first initiate a synchronisation procedure with the other end terminal for synchronising the two terminals with each other and enabling them to start a negotiation procedure. Then they perform the negotiation procedure, which pertains to a transmission rate for communication on the fibre link between the two end terminals, and they execute communication to the other end terminal employing the negotiated transmission rate.

### TECHNICAL FIELD

Embodiments herein relate generally to enabling communication between two end terminals in a fibre optic network, and in particular to enabling communication between two end terminals in a fibre optic network with regard to negotiating transmission rates to be employed when executing communication to and from a first end terminal and a second end terminal.

### BACKGROUND

Fibre optic access networks connect users to a switching equipment of a network operator for processing and further transport of data signals toward a core part of the network.

The access network can be either point-to-point (e.g. Ethernet P2P) or point-to-multipoint fibre topology (e.g. Ethernet Passive Optical Network, EPON, Gigabit Passive Optical Network, GPON, or Wavelength Division Multiplexing Passive Optical Network, WDM-PON). The communicating end terminals are referred to as Optical Network Unit, ONU, at the customer site and Optical Line Terminal, OLT, in a Central Office of the network operator.

In order to reduce cost, the current trend is to reduce the number of central offices in the access network, and to increase the transmission distances as a consequence thereof. This imposes hard requirements on the transmission distances. Up to 100 km transmission distances may need to be supported. Such distances are difficult to achieve with low cost optics. Moreover, the link budget of access networks may be impacted by additional losses such as connectors and impairments such as bends etc. Thus, a fibre link may just be slightly too long or associated with too high losses for the optical transceivers to handle. This may result in a hard stop where the optical transceivers simply do not get the link up for communication between the two end terminals, the ONU and the OLT.

One solution is to use active equipment such as amplifiers along the fibre link in order to amplify and restore the signal as it travels along the fibre link such that it may be received by a receiving end terminal. However, such active equipment is relatively costly to operate and maintain.

### SUMMARY

It is an object of the exemplifying embodiments to address at least some of the problems outlined above. In particular, it is an object of the exemplifying embodiments to provide a first end terminal, a second end terminal, a method in a first end terminal and a method in a second end terminal for enabling communication between the first end terminal and the second end terminal in a fibre optic access network, wherein a transmission rate for communication on the fibre link between the two end terminals is negotiated. These objects and others may be obtained by providing a first end terminal and a second end terminal and a method in a first end terminal and a second end terminal according to the independent claims attached below.

According to an aspect, a method in a first end terminal for enabling communication between the first end terminal and a second end terminal in a fibre optic access network, wherein the method is performed in an arrangement in the first end terminal is provided. The method comprises initiating a synchronisation procedure with the second end terminal for synchronising the two terminals with each other and enabling them to start a negotiation procedure. The method further comprises performing the negotiation procedure with the second end terminal, the negotiation procedure pertaining to a transmission rate for communication on the fibre link between the two terminals, and executing communication 140 to the second end terminal employing the negotiated transmission rate.

According to an aspect, a method in a second end terminal for enabling communication between the end terminal and a first end terminal in a fibre optic access network, wherein the method is performed in an arrangement in the second end terminal is provided. The method comprises receiving an information message from the first end terminal, the information message comprising information pertaining to transmission rate capabilities of the first end terminal, and acknowledging the information message and sending information pertaining to transmission rate capabilities of the second end terminal to the first end terminal. Thereby, the two terminals are synchronised with each other and enabled to start negotiation of the transmission rate to be employed for communication on a fibre link between the first and second end terminal.

According to an aspect, an arrangement in a first end terminal in a fibre optic access network adapted to enable communication between the first end terminal and a second end terminal is provided. The arrangement comprises a processing unit adapted to initiate a synchronisation procedure with the second end terminal for synchronising the two terminals with each other and enabling them to start a negotiation procedure. The processing unit is also adapted to perform the negotiation procedure with the second end terminal, the negotiation procedure pertaining to a transmission rate for communication on the fibre link between the two terminals, and to execute communication to the second end terminal employing the negotiated transmission rate.

According to an aspect, an arrangement in a second end terminal in a fibre optic access network adapted to enable communication between the second end terminal and a first end terminal is provided. The arrangement comprises a processing unit adapted to receive an information message from the first end terminal, the information message comprising information pertaining to transmission rate capabilities of the first end terminal, and to acknowledge the information message and to send information pertaining to transmission rate capabilities of the second end terminal to the first end terminal. Thereby the two terminals are synchronised with each other and enabled to start negotiation of the transmission rate to be employed for communication on a fibre link between the second end terminal and the first end terminal.

The first end terminal, the second end terminal, the method in the first end terminal and the method in the second end terminal have several advantages. By negotiating a transmission rate to be used to execute communication to the second end terminal, the transmission rate can be varied depending on the conditions of the fibre link between the first and the second end terminal. No configuration at the end terminals is required. In case of a relatively long fibre link between the two end terminals, executing communication between the two end terminals may still be possible by lowering the transmission rate, without requiring additional fibre link budget to get the link operational. Further, the first end terminal, the second end terminal and the respective methods therein provide a cost effective alternative to using active equipment such as amplifiers along the fibre link, since such active equipment is relatively costly to operate and maintain.

### BRIEF DESCRIPTION OF DRAWINGS

Embodiments will now be described in more detail in relation to the accompanying drawings, in which:

FIG. 1a is a flowchart of an exemplifying embodiment of a method in a first end terminal for enabling communication between the first end terminal and a second end terminal.

FIG. 1b is a flowchart of another exemplifying embodiment of a method in a first end terminal for enabling communication between the first end terminal and a second end terminal.

FIG. 1c is a flowchart of yet another exemplifying embodiment of a method in a first end terminal for enabling communication between the first end terminal and a second end terminal.

FIG. 1d is a flowchart of yet another exemplifying embodiment of a method in a first end terminal for enabling communication between the first end terminal and a second end terminal.

FIG. 2a is a flowchart of an exemplifying embodiment of a method in a second end terminal for enabling communication between the second end terminal and a first end terminal.

FIG. 2b is a flowchart of another exemplifying embodiment of a method in a second end terminal for enabling communication between the second end terminal and a first end terminal.

FIG. 3 is a block diagram schematically illustrating an exemplifying embodiment of first end terminal and a second end terminal adapted to enable communication between the first end terminal and the second end terminal.

FIG. 4 is a block diagram schematically illustrating an exemplifying embodiment of first end terminal and a second end terminal adapted to enable communication between the first end terminal and the second end terminal.

FIG. 5 is a block diagram schematically illustrating an exemplifying embodiment of an end terminal adapted to enable communication with another end terminal.

FIG. 6 is a block diagram schematically illustrating an exemplifying information message.

FIG. 7 is a block diagram schematically illustrating an exemplifying transmission test message.

### DETAILED DESCRIPTION

Briefly described, exemplifying embodiments of a method in a first end terminal and a method in a second end terminal, as well as an arrangement in a first end terminal and an arrangement in a second end terminal, are provided for enabling communication between the first end terminal and the second end terminal in a fibre optic access network. The enabling of communication between the two terminals over a fibre link or fibre path comprises negotiating transmission rates to be used when communicating between the two terminals.

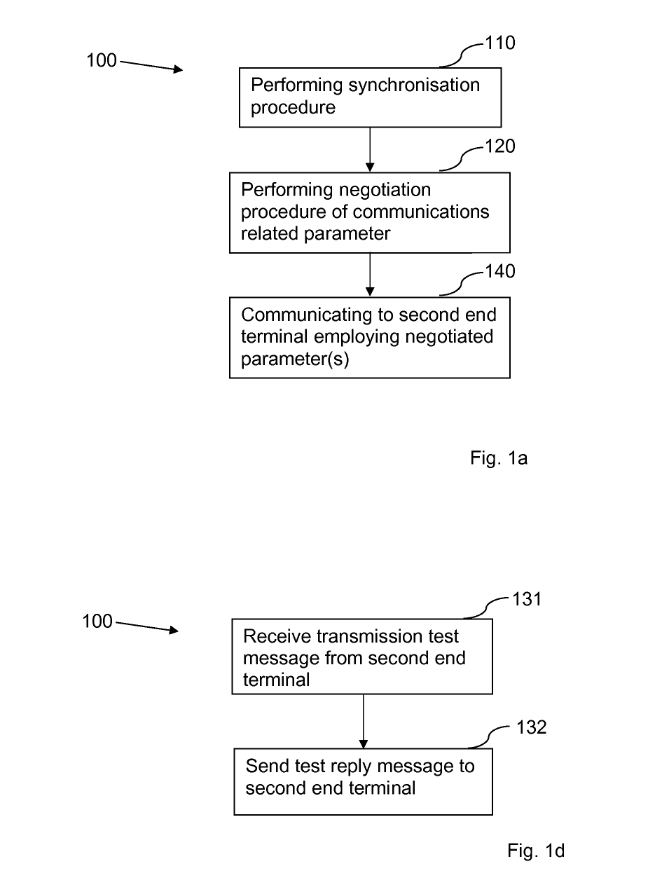

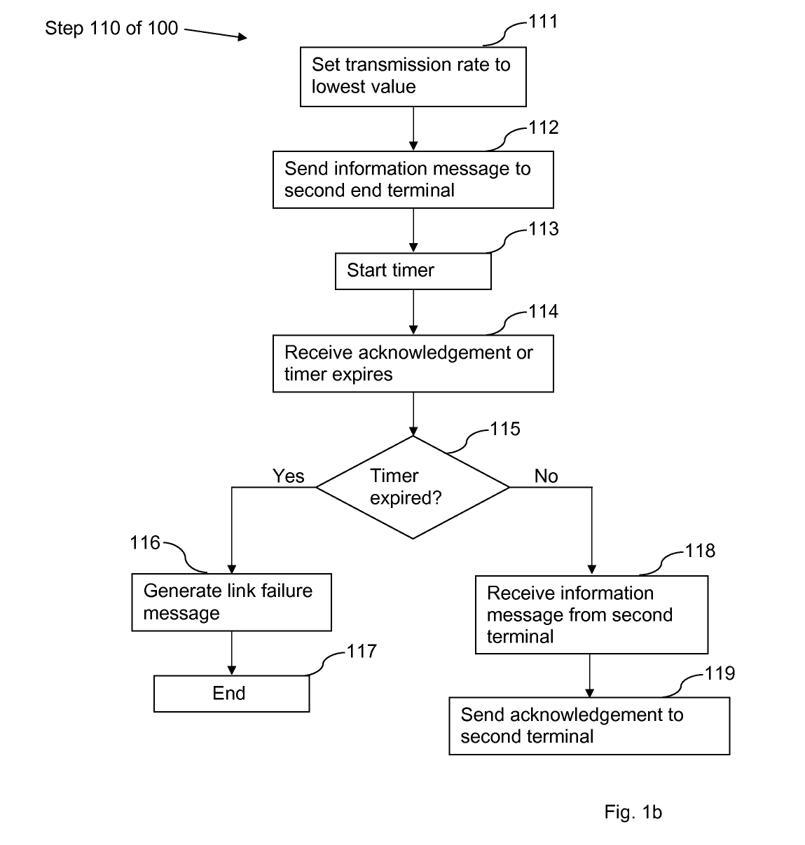

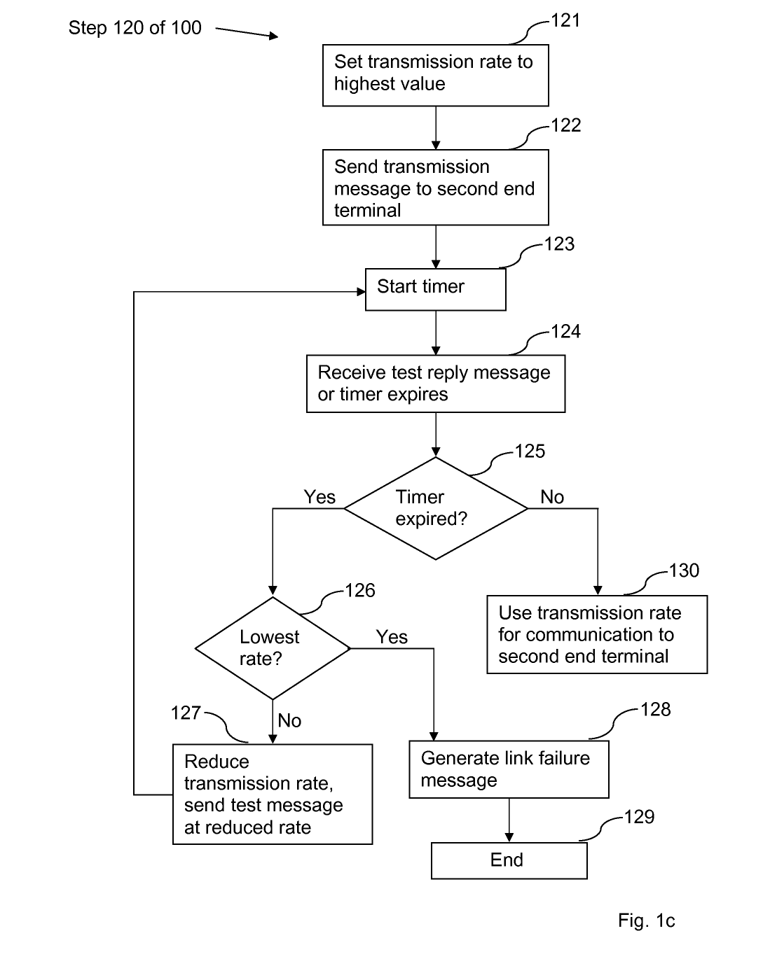

An exemplifying embodiment of a method in a first end terminal for enabling communication between the first end terminal and a second end terminal in a fibre optic access network, wherein the method is performed in an arrangement in the first end terminal will now be described with reference to FIG. 1a. FIG. 1a is a flowchart of an exemplifying embodiment of a method in a first end terminal for enabling communication between the first end terminal and a second end terminal.

In this example, the method performed in an arrangement in the first end terminal comprises initiating 110 a synchronisation procedure with the second end terminal for synchronising the two terminals with each other and enabling them to start a negotiation procedure. The method further comprises performing 120 the negotiation procedure with the second end terminal, the negotiation procedure pertaining to a transmission rate for communication on the fibre link between the two terminals, and executing communication 140 to the second end terminal employing the transmission rate. The transmission rate is the result of the negotiation procedure.

This exemplifying method has several advantages. By negotiating a transmission rate to be used to execute communication to the second end terminal, the transmission rate can be varied depending on the conditions of the fibre link between the first and the second end terminal. No configuration at the end terminals is required. In case of a relatively long fibre link between the two end terminals, executing communication between the two end terminals may still be possible by lowering the transmission rate, without requiring additional fibre link budget to get the link operational. Further, the method provides a cost effective alternative to using active equipment such as amplifiers along the fibre link, since such active equipment is relatively costly to operate and maintain.

A doubling of transmission speed is approximately equivalent to 3 dB of optical loss budget, or conversely, halving the transmission speed is approximately equivalent to gaining 3 dB of budget. A bit which is transmitted at half the transmission rate contains twice as much energy and is therefore approximately twice as robust to impairments. As a consequence, by lowering the transmission rate, the transmitted bits in a signal will have a higher likelihood of being successfully received at the receiver as compared to bits transmitted in a signal at a higher transmission rate.

FIG. 1b is a flowchart of another exemplifying embodiment of a method in a first end terminal for enabling communication between the first end terminal and a second end terminal. The flowchart illustrates the synchronisation procedure 110 of FIG. 1a in more detail.

According to an embodiment of the method performed in an arrangement in the first end terminal, the synchronisation procedure 110 comprises setting 111 the transmission rate to a lowest value and sending 112 an information message to the second end terminal, the information message comprising information pertaining to transmission rate capabilities of the first end terminal, the message being sent at the lowest transmission rate. The method further comprises starting 113 a preset timer. If the timer expires before an acknowledgement message is received from the second end terminal, the method comprises generating 116 a link failure message and ending 117 the method; or if an acknowledgement message from the second end terminal is received 114 before the timer expires, the method comprises receiving 118 an information message from the second end terminal, the information message comprising information pertaining to transmission rate capabilities of the second end terminal, thereby synchronising the two terminals with each other and enabling them to start negotiation 120 of transmission rate.

Before the negotiation procedure starts, the two end terminals should synchronise with each other. By initiating the synchronisation by sending 112 an information message to the second end terminal at the lowest transmission rate, the probability that the information message will be received by the second end terminal is increased as compared to sending the information message at a higher transmission rate. This is because the longer the fibre length, the lower the transmission rate needs to be in order to successfully convey a transmitted signal over the fibre link. As a consequence, the probability that the synchronisation procedure will be successful so that the terminals can start transmission rate negotiation will also be increased. In this exemplifying embodiment, after the first end terminal receives an acknowledgement from the second end terminal that the second end terminal successfully received the information message sent by the first end terminal, the first end terminal receives an information message from the second end terminal. In an example, the first end terminal also sends an acknowledgement to the second end terminal confirming successful reception of the information message.

According to an embodiment of the method performed in an arrangement in the first end terminal, the synchronisation procedure 110 comprises setting 111 the transmission rate to a lowest value and sending 112 an information message to the second end terminal, the information message comprising information pertaining to transmission rate capabilities of the first end terminal, the message being sent at the lowest transmission rate. The method further comprises starting 113 a preset timer. The method further comprises receiving 114 an acknowledgement message from the second end terminal before the timer expires, the acknowledgement message comprising information pertaining to transmission rate capabilities of the second end terminal, the message being received at the lowest transmission rate thereby synchronising the two terminals with each other and enabling them to start negotiation 120 of transmission rate; or if the timer expires before an acknowledgement message is received, the method comprises generating 116 a link failure message and ending 117 the method.

In this exemplifying embodiment, the acknowledgement message received from the second end terminal comprises information pertaining to transmission rate capabilities of the second end terminal. In other words, the acknowledgement message in this exemplifying embodiment constitutes both an acknowledgment of successful reception of the information message sent from the first end terminal and also an information message from the second end terminal. So the acknowledgment in this embodiment corresponds to the acknowledgment plus the information message described in the previous exemplifying embodiment.

FIG. 1c is a flowchart of yet another exemplifying embodiment of a method in a first end terminal for enabling communication between the first end terminal and a second end terminal. The flowchart illustrates the negotiation procedure 120 of FIG. 1a in more detail.

According to an embodiment of the method performed in an arrangement in the first end terminal, the negotiation procedure 120 comprises setting 121 the transmission rate to a highest value and sending 122 a first transmission test message to the second end terminal at the highest transmission rate. The method further comprises starting 123 a preset timer. The method further comprises receiving 124 a test reply message from the second end terminal before the timer expires confirming reception of the transmission test message sent at the highest transmission rate and using 130 the highest transmission rate for executing communication to the second end terminal; or if the timer expires before a test reply message is received, reducing 127 the transmission rate and sending a second transmission test message to the second end terminal at the reduced transmission rate, and restarting 123 the timer.

In case the first transmission test message which is sent 122 to the second end terminal is acknowledged, then this means that the first end terminal can use the highest transmission rate when executing communication over the fibre link to the second end terminal. However, if the timer expires before an acknowledgement is received from the second end terminal, the first end terminal deduces that the second end terminal did not receive the first transmission test message sent at the highest transmission rate and that the fibre link between the two terminals is not able to support communication sent from the first end terminal to the second end terminal at the highest transmission rate. As a consequence, the first end terminal reduces the transmission rate and tries again to send a transmission test message, i.e. the second transmission test message, to the second end terminal to see if the fibre link between the two terminals supports the reduced transmission rate.

According to yet another embodiment of the method performed in an arrangement in the first end terminal, if the timer expires before a test reply message is received, the method comprises further reducing 127 the transmission rate and sending a further transmission test message to the second end terminal at the further reduced transmission rate, and restarting 123 the timer; or if the test reply message is received from the second terminal before the timer expires the method comprises confirming reception of the transmission test message sent at the reduced transmission rate, using 130 the reduced transmission rate for executing communication to the second end terminal.

In case the second transmission test message which is sent 127 at a reduced transmission rate to the second end terminal is acknowledged, then this means that the first end terminal can use this reduced transmission rate when executing communication over the fibre link to the second end terminal. However, if the timer expires before an acknowledgement is received from the second end terminal, the first end terminal deduces that the second end terminal did not receive the second transmission test message sent at the reduced transmission rate and that the fibre link between the two terminals is not able to support communication sent from the first end terminal to the second end terminal at this reduced transmission rate. As a consequence, the first end terminal further reduces the transmission rate and tries again to send a transmission test message to the second end terminal to see if the fibre link between the two terminals supports the further reduced transmission rate.

According to an embodiment, the method further comprises repeating the steps described above until either a test reply message is received from the second end terminal confirming reception of the transmission test message sent at a specific reduced transmission rate, wherein the specific transmission rate will be used 130 for executing communication to the second end terminal; or until a transmission test message has been sent to the second end terminal using the lowest transmission rate and a timer for this transmission has expired, wherein a link failure message is generated 128 and the method is ended 129.

This means that the first end terminal will continue to reduce the transmission rate and send test messages to the second end terminal at the successively reduced rates until the second end terminal either successfully receives a test message sent at a specific reduced transmission rate, or until the lowest possible or acceptable transmission rate has been used to send a test message to the second end terminal but no acknowledgement has been received. This then means that communication cannot be performed on the fibre link to the second end terminal and hence a link failure message is generated. The lowest rate is in one example the lowest rate supported by the end terminal. In another example, the lowest rate is the rate at which communications is worthwhile, which may be greater than the lowest value 111 at which the synchronization process 110 was achieved. For example, suppose the two end terminals synchronise with each other at a transmission rate of 10 Mb/s, but it is not worthwhile trying to carry bearer traffic at less than 100 Mb/s. In such a case, the lowest possible or acceptable transmission rate is higher than the transmission rate used for synchronising the two end terminals

FIG. 1d is a flowchart of another exemplifying embodiment of a method in a first end terminal for enabling communication between the first end terminal and a second end terminal.

According to this embodiment, the method in the first terminal further comprises receiving 131 a transmission test message at a specific transmission rate from the second end terminal, and sending 132 a test reply message to the second end terminal confirming reception of the transmission test message, thereby confirming to the second end terminal the specific transmission rate with which the transmission test message was received.

This means that also the transmission rate to be used when executing communication from the second end terminal to the first end terminal is being negotiated. This also implies that the first end terminal may execute communication to the second end terminal at a first transmission rate, assuming the negotiation procedure was successful, and receive communication from the second end terminal at a second transmission rate, where the first and the second transmission rate may be different, i.e. asymmetric transmission rates.

In an example, the test reply messages are transmitted at the lowest transmission rate. In case of asymmetric transmission rates, a received transmission test message received at a highest transmission rate cannot be acknowledged with a test reply message sent at the same highest transmission rate in case the transmission rate towards the sender of the transmission test message is lower than the maximum transmission rate. By transmitting test reply messages at the lowest transmission rate, it is ensured that the test reply message will be received by a receiver.

According to yet an embodiment, the method further comprises negotiating with the second end terminal, one or more further parameters to be used for communication on the link from the first end terminal to the second end terminal.

In addition to the transmission rate, several other parameters may be negotiated, both with regard to communication to the second end terminal and also with regard to communication received from the second end terminal.

According to an embodiment, the further parameters comprise any of Forward Error Correction, FEC, cryptographic capabilities and usage, modulation format and parameters.

Of course also other parameters not mentioned here may be the subject of negotiation between the first and the second end terminals. Further, this implies that the communication executed to the second end terminal but also communication received from the second end terminal, may employ the same or different transmission rates and employ the same or different error correction schemes, cryptographic capabilities and modulation, as long as the different parameters are supported by both end terminals.

According to still an embodiment of the method in the first end terminal, the method is performed at link setup between the first and the second end terminals.

As the first end terminal wishes to establish a communication session of some sort with the second end terminal, the first end terminal first synchronises itself with the second end terminal. After the synchronisation the first end terminal negotiates with the second end terminal in order to find a transmission rate to be used for executing communication to the second end terminal. Further, the transmission rate to be used for receiving communication from the second end terminal is negotiated. Optionally, further parameters related to the communication, also with regard to the fibre link between the two terminals, may be negotiated. Once this is done, communication may take place on the fibre link between the two end terminals.

According to yet an embodiment of the method in the first end terminal, the method is performed in response to the first end terminal detecting a link failure during an ongoing communication between the first and the second end terminal.

In case the communication is ongoing, a link failure may occur which may result in the communication between the end terminals being lost or severely degraded. In such a case, it may be necessary to, so to say, start over again and negotiate the transmission rate to be employed when executing communication to the second end terminal and the transmission rate at which communication is received from the second end terminal. Optionally again, further parameters related to the communication, also with regard to the fibre link between the two terminals, may be negotiated once again. It may also be necessary to execute the synchronisation procedure again before performing the negotiation procedure.

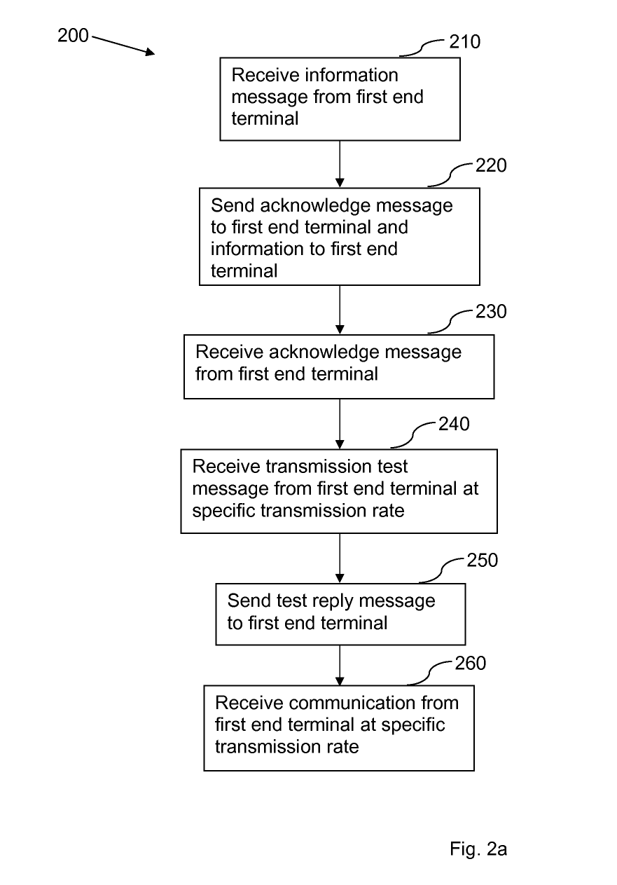

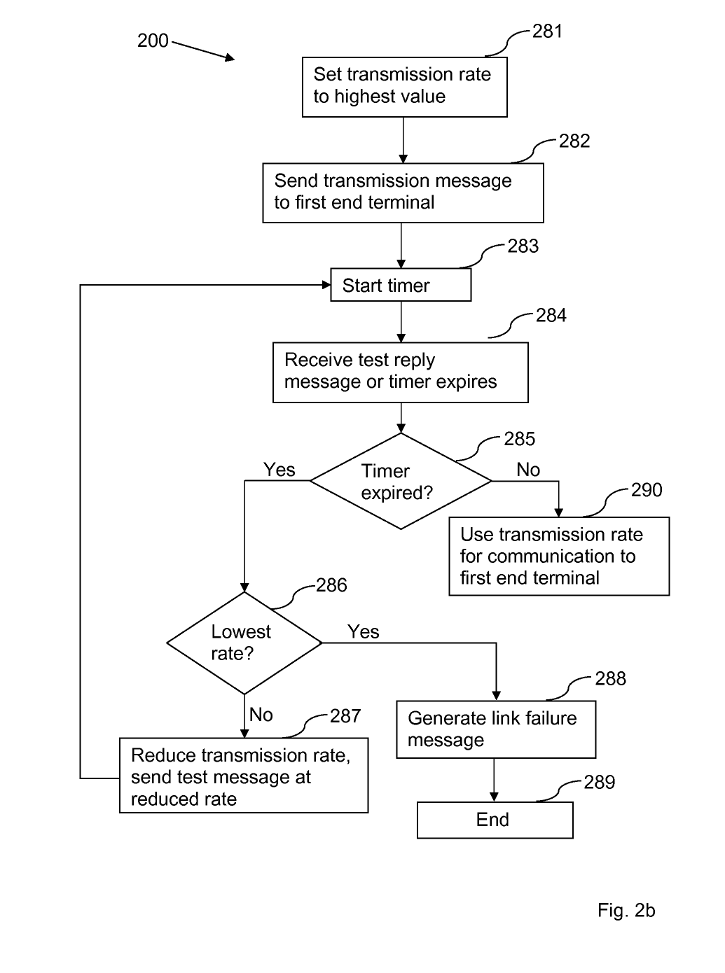

An exemplifying embodiment of a method in a second end terminal for enabling communication between the second end terminal and a first end terminal in a fibre optic access network, wherein the method is performed in an arrangement in the second end terminal will now be described with reference to FIG. 2a. FIG. 2a is a flowchart of an exemplifying embodiment of a method in a second end terminal for enabling communication between the second end terminal and a first end terminal.

In this example, the method performed in an arrangement in the second end terminal comprises receiving 210 an information message from the first end terminal, the information message comprising information pertaining to transmission rate capabilities of the first end terminal, and acknowledging 220 the information message and sending information pertaining to transmission rate capabilities of the second end terminal to the first end terminal. Thereby, the two terminals are synchronised with each other and enabled to start negotiation of the transmission rate to be employed for communication on a fibre link between the first and second end terminal.

This exemplifying method has the same advantages as the method performed in an arrangement in the first end terminal. By negotiating a transmission rate to be used to execute communication to the second end terminal, the transmission rate can be varied depending on the conditions of the fibre link between the first and the second end terminal. No configuration at the end terminals is required. In case of a relatively long fibre link between the two end terminals, executing communication between the two end terminals is still possible by lowering the transmission rate, without requiring additional fibre link budget to get the link operational. Further, the method provides a cost effective alternative to using active equipment such as amplifiers along the fibre link, since such active equipment is relatively costly to operate and maintain.

According to an embodiment, the acknowledging 220 of the information message and sending information pertaining to transmission rate capabilities of the second end terminal comprises sending one acknowledgement message comprising the information pertaining to transmission rate capabilities of the second end terminal; or sending a separate acknowledgement message and a separate information message comprising information pertaining to transmission rate capabilities of the second end terminal.

As was described above, the acknowledgement message may either constitute both an acknowledgment of successful reception of the information message sent from the first end terminal and also an information message from the second end terminal to the first end terminal; or the messages are, so to say, separated such that a separate acknowledgement message is sent and a separate information message is also sent to the first end terminal.

According to an embodiment of the method performed in an arrangement in the second end terminal, the method further comprises receiving 240 successfully a transmission test message from the first end terminal at a specific transmission rate. The method also comprises sending 250 a test reply message to the first terminal confirming the reception of the transmission test message at the specific transmission rate and receiving 260 communications from the first end terminal at the specific transmission rate.

This means that the acknowledgement message sent to the first end terminal comprising also information pertaining to transmission rate capabilities of the second end terminal was successfully received by the first end terminal; or the acknowledgement message and the information message sent from the second end terminal were successfully received by the first end terminal. The first end terminal has now initiated the negotiation procedure and the received transmission test message is the first received transmission test message.

This received transmission test message may be the first transmission message sent from the first end terminal at the highest transmission rate. It may also be a transmission test message having been sent by the first end terminal at a reduced transmission rate. In any case it is the first successfully received transmission test message and it indicates the highest possible transmission rate with which communication may be received from the first end terminal, or in other words, the highest possible transmission rate the first end terminal may employ to execute communication to the second end terminal.

FIG. 2b is a flowchart of another exemplifying embodiment of a method in an arrangement in a second end terminal for enabling communication between the second end terminal and a first end terminal.

FIG. 2 illustrates the method comprising setting 281 the transmission rate to a highest value, sending 282 a first transmission test message to the first end terminal at the highest transmission rate and starting 283 a preset timer. The method further comprises receiving 284 a test reply message from the first terminal before the timer expires confirming reception of the transmission test message sent at the highest transmission rate and using 290 the highest transmission rate for executing communication to the first end terminal; or if the timer has expired before a test reply message is received, the method comprises reducing 287 the transmission rate and sending a second transmission test message to the first end terminal at the reduced transmission rate, and restarting 283 the timer.

This means that if a test reply message is received 284 before the timer expires confirming reception of the transmission test message sent at the highest transmission rate, then the fibre link between the second end terminal and the first end terminal supports communication transmitted from the second end terminal to the first end terminal at the highest transmission rate with which the second end terminal is able to transmit communication to the first end terminal.

On the other hand, if the timer expires 284 before a test reply message is received, the fibre link is not capable of supporting communication transmitted from the second end terminal to the first end terminal at the highest transmission rate with which the second end terminal is able to transmit communication to the first end terminal. Then the transmission rate is reduced 287 and a new attempt to send a transmission test at this reduced transmission rate is performed.

According to an embodiment of the method performed in an arrangement in the second end terminal, the method further comprises, if the timer expires 284 before a test reply message is received, further reducing 287 the transmission rate and sending a further transmission test message to the first end terminal at the further reduced transmission rate, and restarting the timer 283; or if the test reply message is received 284 from the first terminal confirming reception of the transmission test message sent at the reduced transmission rate, using 290 the reduced transmission rate for executing communication to the first end terminal.

This means that if the test reply message is received 284 from the first terminal confirming reception of the transmission test message sent at the reduced transmission rate, the fibre link is capable of supporting communication transmitted from the second end terminal to the first end terminal at the reduced transmission rate and this transmission rate is then used to execute communication to the first end terminal.

On the other hand, if the timer expires 284 before a test reply message is received, then the fibre link is not capable of supporting communication transmitted from the second end terminal to the first end terminal at the reduced transmission rate. Then the transmission rate is further reduced 287 and a new attempt to send a transmission test at this further reduced transmission rate is performed.

According to still an embodiment of the method performed in an arrangement in the second end terminal, the method further comprises repeating the steps described above until either a test reply message 284 is received from the first end terminal confirming reception of a transmission test message sent at a specific reduced transmission rate, wherein the specific transmission rate will be used 290 for executing communication to the first end terminal; or until a transmission test message has been sent to the first end terminal using the lowest transmission rate and a timer for this transmission has expired 284, wherein a link failure message is generated 288 and the method is ended 289.

This means that the second end terminal will keep on trying to negotiate a transmission rate to be used for executing communication to the first end terminal by reducing the transmission rate, send a transmission test message at this reduced rate until the lowest possible transmission rate has been attempted but no test reply is received. Then the second end terminal deduces that it is not possible to execute communication to the first end terminal, with regard to the fibre link, using any the transmission rates which are supported by the second end terminal. Then the second end terminal generates 288 a link failure message.

According to yet an embodiment of the method performed in an arrangement in the second end terminal, the method further comprises negotiating with the first end terminal, one or more further parameters to be used for communication on the link from the second end terminal to the first end terminal.

In addition to the transmission rate, several other parameters may be negotiated, both with regard to communication to the first end terminal and also with regard to communication received from the first end terminal.

According to an embodiment of the method performed in an arrangement in the second end terminal, the parameters comprise any of Forward Error Correction, FEC, cryptographic capabilities and usage, modulation format and parameters.

Of course also other parameters not mentioned here may be the subject of negotiation between the second and the first end terminals. Further, this implies that the communication executed to the first end terminal but also communication received from the first end terminal, may employ the same or different transmission rates and employ the same or different error correction schemes, cryptographic capabilities and modulation, as long as the different parameters are supported by both end terminals.

According to still an embodiment, the method is performed at link setup between the second end terminal and the first end terminal.

As the first end terminal wishes to establish a communication session of some sort with the second end terminal, the first end terminal first synchronises itself with the second end terminal. After the synchronisation the first end terminal negotiates with the second end terminal in order to find a transmission rate to be used for executing communication to the second end terminal. Further, the transmission rate to be used for receiving communication from the second end terminal is negotiated. Optionally, further parameters related to the communication, also with regard to the fibre link between to two terminals, may be negotiated. Once this is done, the communication may take place on the fibre link between the two end terminals.

According to yet an embodiment, the method is performed in response to the first end terminal detecting a link failure during an ongoing communication between the second and the first end terminal.

In case the communication is ongoing, a link failure may occur which may result in the communication between the end terminals being lost or severely degraded. In such a case, it may be necessary to, so to say, start over again and negotiate the transmission rate to be employed when executing communication to the second end terminal and with which transmission rate communication is received from the second end terminal. Optionally again, further parameters related to the communication, also with regard to the fibre link between to two terminals, may be negotiated once again. It may also be necessary to execute the synchronisation procedure again before performing the negotiation procedure.

During an ongoing communication between the two end terminals, one of them may detect a link failure. In an example, the end terminal that detects the link failure will become the first end terminal that initiates the reconnection according to the method in a first end terminal as described above. This means that, in the example that during an ongoing communication between the first end terminal and the second end terminal, it is the second end terminal in the ongoing communication that detects the link failure, then the second end terminal will be the one that will act as the first end terminal in the attempt to re-establish the connection by initiating the negotiation procedure.

In another example, it is the second end terminal that detects the fault, but in this example waits until the first end terminal detects the same link failure and subsequently the first end terminal will attempt to re-establish the connection by initiating the negotiation procedure.

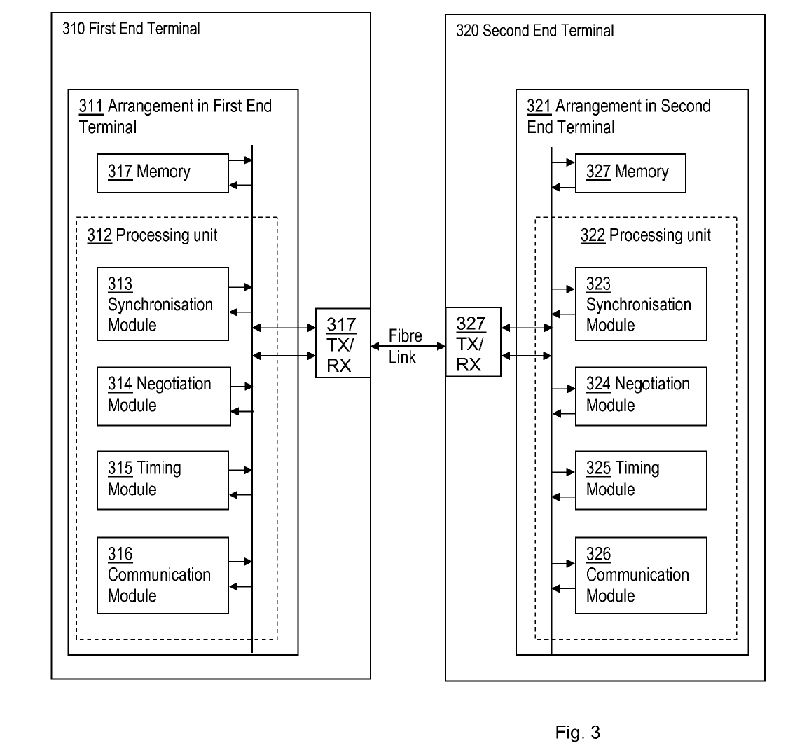

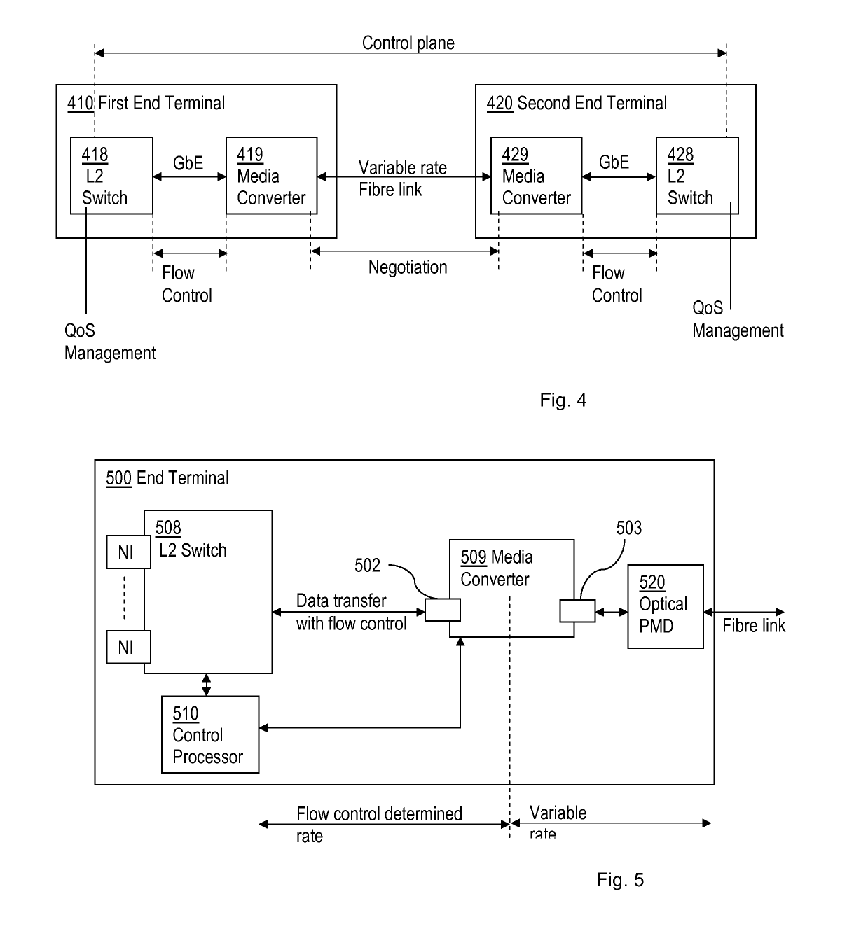

Exemplifying embodiments of an arrangement in a first end terminal and an arrangement in a second end terminal adapted to enable communication between the first end terminal and the second end terminal will now be described with reference to FIGS. 3 and 4. The arrangement in the first end terminal and the arrangement in the second end terminal have the same objects, advantages and technical features as the methods therein described above. Therefore, the respective arrangement will described briefly in order to avoid unnecessary repetition.

FIG. 3 is a block diagram schematically illustrating an exemplifying embodiment of an arrangement in a first end terminal and an arrangement in a second end terminal adapted to enable communication between the first end terminal and the second end terminal.

FIG. 3 illustrates the arrangement 311, 419 in a first end terminal 310, 410 in a fibre optic access network adapted to enable communication between the first end terminal 310, 410 and a second end terminal 320, 420, the arrangement 311, 419 comprising a processing unit 312 adapted to initiate a synchronisation procedure with the second end terminal 320, 420 for synchronising the two terminals with each other and enabling them to start a negotiation procedure. The processing unit 312 is also adapted to perform the negotiation procedure with the second end terminal 320, 420, the negotiation procedure pertaining to a transmission rate for communication on the fibre link between the two terminals, and to execute communication to the second end terminal 320, 420 employing the negotiated transmission rate.

According to an embodiment, the processing unit 312 is adapted to set the transmission rate to a lowest value, to send an information message to the second end terminal 320, 420, the information message comprising information pertaining to transmission rate capabilities of the first end terminal 310, 410, the message being sent at the lowest transmission rate, and to start a preset timer. If the timer expires before an acknowledgement message is received from the second end terminal 320, 420, the processing unit 312 is adapted to generate a link failure message; or the processing unit is adapted to receive an acknowledgement message from the second end terminal (320, 420) before the timer expires, and to receive an information message from the second end terminal 320, 420, the information message comprising information pertaining to transmission rate capabilities of the second end terminal 320, 420, thereby synchronising the two terminals with each other and enabling them to start negotiation of transmission rate.

According to yet an embodiment, the processing unit 312 is further adapted to set the transmission rate to a lowest value, send an information message to the second end terminal 320, 420, the information message comprising information pertaining to transmission rate capabilities of the first end terminal 310, 410, the message being sent at the lowest transmission rate, and to start a preset timer. The processing unit 312 is further adapted to receive an acknowledgement message from the second end terminal 320, 420 before the timer expires, the acknowledgement message comprising information pertaining to transmission rate capabilities of the second end terminal 320, 420, thereby synchronising the two terminals with each other and enabling them to start negotiation of transmission rate. If the timer expires before an acknowledgement message is received from the second end terminal 320, 420, the processing unit 312 is adapted to generate a link failure message.

According to yet an embodiment, the processing unit 312 is adapted to set the transmission rate to a highest value, to send a first transmission test message to the second end terminal 320, 420 at the highest transmission rate and to start a preset timer. The processing unit 312 is also adapted to receive a test reply message from the second end terminal 320, 420 before the timer expires confirming reception of the transmission test message sent at the highest transmission rate and use the highest transmission rate for executing communication to the second end terminal 320, 420; or if the timer expires before a test reply message is received, the processing unit 312 is adapted to reduce the transmission rate and to send a second transmission test message to the second end terminal 320, 420 at the reduced transmission rate, and restart the timer.

According to still an embodiment, if the timer expires before a test reply message is received, the processing unit 312 is adapted to further reduce the transmission rate and send a further transmission test message to the second end terminal 320, 420 at the further reduced transmission rate, and restart the timer. If a test reply message is received from the second end terminal 320, 420 before the timer expires, the processing unit 312 is adapted to confirm reception of the transmission test message sent at the reduced transmission rate, and to use the reduced transmission rate for executing communication to the second end terminal 320, 420.

According to an embodiment, the processing unit 312 is further adapted to repeat the steps described above of reducing the transmission rate, until either a test reply message is received from the second end terminal 320, 420 confirming reception of the transmission test message sent at a specific reduced transmission rate, wherein the processing unit 312 is adapted to use the specific transmission rate for executing communication to the second end terminal 320, 420; or until a transmission test message has been sent to the second end terminal 320, 420 using the lowest transmission rate and a timer for this transmission has expired, wherein the processing unit 312 is adapted to generate a link failure message.

According to an embodiment, the processing unit 312 is further adapted to receive a transmission test message at a specific transmission rate from the second end terminal 320, 420, and to send a test reply message to the second end terminal 320, 420 confirming reception of the transmission test message, thereby confirming to the second end terminal 320, 420 the specific transmission rate with which the transmission test message was received.

In still an embodiment, the processing unit 312 is further adapted to negotiate with the second end terminal 320, 420, one or more further parameters to be used for communication on the link from the first end terminal 310, 410 to the second end terminal 320, 420.

In yet an embodiment, the further parameters comprise any of Forward Error Correction, FEC, cryptographic capabilities and usage, modulation format and parameters.

According to an embodiment, the processing unit 312 is adapted to perform the steps at link setup between the first and the second end terminals.

According to an embodiment, the processing unit 312 is adapted to perform the steps in response to the first end terminal 310, 410 detecting a link failure during an ongoing communication between the first and the second end terminal.

As stated above, exemplifying embodiments of an arrangement in a second end terminal will be described with reference to FIGS. 3 and 4.

FIG. 3 illustrates the arrangement 321, 429 in a second end terminal 320, 420 in a fibre optic access network adapted to enable communication between the second end terminal 320, 420 and a first end terminal 310, 410, the arrangement comprising a processing unit 322 adapted to receive an information message from the first end terminal 310, 410, the information message comprising information pertaining to transmission rate capabilities of the first end terminal 310, 410, and to acknowledge the information message and to send information pertaining to transmission rate capabilities of the second end terminal 320, 420 to the first end terminal. Thereby the two terminals are synchronised with each other and enabled to start negotiation of the transmission rate to be employed for communication on a fibre link between the second end terminal and the first end terminal.

According to an embodiment of the arrangement 321, 429 in the second end terminal 320, 420, the processing unit 322 is adapted to acknowledge the information message and to send information pertaining to transmission rate capabilities of the second end terminal 320, 420 by sending one acknowledgement message comprising the information pertaining to transmission rate capabilities of the second end terminal 320, 420; or to send a separate acknowledgement message and a separate information message comprising information pertaining to transmission rate capabilities of the second end terminal 320, 420.

According to yet an embodiment of the arrangement 321, 429 in the second end terminal 320, 420, the processing unit 322 is adapted to successfully receive a transmission test message from the first end terminal 310, 410 at a specific transmission rate, send a test reply message to the first terminal 310, 410 confirming the reception of the transmission test message at the specific transmission rate, and to receive communication from the first terminal 310, 410 at the specific transmission rate.

In an embodiment, the processing unit 322 is adapted to set the transmission rate to a highest value, to send a first transmission test message to the first end terminal 310, 410 at the highest transmission rate, and to start a preset timer. The processing unit 322 is also adapted to receive a test reply message from the first terminal 310, 410 before the timer expires confirming reception of the transmission test message sent at the highest transmission rate and use the highest transmission rate for executing communication to the first end terminal 310, 410; or if the timer has expired before a test reply message is received, the processing unit 322 is adapted to reduce the transmission rate and send a second transmission test message to the first end terminal 310, 410 at the reduced transmission rate, and restart the timer.

According to an embodiment, if the timer expires before a test reply message is received, the processing unit 322 is adapted to further reduce the transmission rate and to send a further transmission test message to the first end terminal 310, 410 at the further reduced transmission rate, and restart the timer; or if a test reply message is received from the first terminal 310, 410 confirming reception of the transmission test message sent at the reduced transmission rate, the processing unit 322 is adapted to use the reduced transmission rate for executing communication to the first end terminal 310, 410.

According to an embodiment, the processing unit 322 is adapted to repeat the steps described above until either a test reply message is received from the first end terminal 310, 410 confirming reception of a transmission test message sent at a specific reduced transmission rate, wherein the processing unit 322 is adapted to use the specific transmission rate for executing communication to the first end terminal (310, 410); or until a transmission test message has been sent to the first end terminal 310, 410 using the lowest transmission rate and a timer for this transmission has expired, wherein the processing unit 322 is adapted to generate a link failure message.

According to still an embodiment, the processing unit 322 is adapted to negotiate with the first end terminal 310, 410, one or more further parameters to be used for communication on the link from the second end terminal 320, 420 to the first end terminal 310, 410.

In an example, the further parameters comprise any of Forward Error Correction, FEC, cryptographic capabilities and usage, modulation format and parameters.

According to yet an embodiment, the processing unit 322 is adapted to perform the steps as described above with regard to the arrangement in the second end terminal at link setup between the second end terminal and the first end terminal.

According to still an embodiment, the processing unit (322) is adapted to perform the steps as described above with regards to the arrangement in the second end terminal in response to the first end terminal (310, 410) detecting a link failure during an ongoing communication between the second and the first end terminal.

The respective arrangement in the first end terminal and in the second end terminals and the respective method performed therein enables the physical transmission rate over an optical fibre link to be adjusted to optimise communication performance to a specific fibre link scenario.

The first end terminal and the second end terminal are in an example an Optical Line Terminal, OLT, and an Optical Network Unit, ONU. According to an embodiment, the OLT is the first terminal, which is in charge of the synchronisation procedure and the negotiation procedure.

FIG. 4 is a block diagram schematically illustrating an exemplifying embodiment of a first end terminal and a second end terminal adapted to enable communication between the first end terminal and the second end terminal. To support variable transmission rate over the fibre link between the first end terminal 410 and the second end terminal 420, the two end terminals are configured with a respective arrangement as described above and illustrated in FIG. 4 as respective media converters 419, 429. FIG. 4 also illustrates the two end terminals comprising respective Layer 2 (L2) and switches 418, 428. The L2 switches 418 and 428 communicate with each other, in one example, via a Gigabit Ethernet link. This Gigabit Ethernet link is served in each end terminal by the respective media converters 419 and 429.

The media converters 419 and 429 communicate with each other over the fibre link at a transmission rate of e.g. 1 Gbit/s or lower. The media converters 419 and 429 are further adapted to hide the physical layer details of the communication link from the respective L2 switches 418 and 428. In this example the media converters 419 and 429 are capable of rate adaptation. As having been described above, the media converters correspond to the respective arrangements in the first and second end terminal. They are adapted to convert the media or data between the interface between the respective L2 switch 418, 428 and the optical fibre interface. In other words, the media converters 419 and 429 are adapted to act as interfaces between the two L2 switches 418 and 428. The respective media converters 419 and 429 communicate with the respective L2 switches over respective internal GbE interfaces. The instantaneous transmission rate between the respective L2 switches 418, 428 and the media converters 419, 429 may differ from the transmission rate negotiated in each direction over the optical fibre link between the two media converters 419 and 429. As a consequence, the media converters 419 and 429 are adapted to employ flow control on the respective GbE interface toward the respective L2 switches 418, 428.

The media converters 419 and 429 are also adapted to provide clock asynchronicity between the physical interfaces of the two ports of the media converter, whereby the clock rate used for communication on the fibre is not necessarily a multiple or sub-multiple of the clock rate used on the internal GbE interface to the L2 switch. In an example, this also includes buffering of some traffic or data in the media converter.

In one example, the media converters 419 and 429 are configured to adapt the transmission rate of the interface toward the optical fibre link as a result of the above described negotiation of transmission rate between the two end terminals, performed by the media converters 419, 429 corresponding to the arrangements 311, 321 in the respective end terminals. In another example, the media converters 419 and 429 are configured to adapt the transmission rate of the interface toward the optical fibre link as a response to a command from the control plane.

In an embodiment, the exemplifying embodiments of the media converters are implemented in a digital circuit, such as an Application Specific Integrated Circuit, ASIC, or a Field Programmable Gate Array, or FPGA, that resides between a fibre optic transceiver and the higher layer (L2, L3 and above) processing devices. In another embodiment, the exemplifying embodiments of the media converters are integrated with other devices such as the L2/L3 switch or the fibre optic transceiver.

FIG. 5 is a block diagram schematically illustrating an exemplifying embodiment of an end terminal adapted to enable communication with another end terminal. The end terminal illustrated in FIG. 5 is in one example an OLT and in another example an ONU in a Wavelength Division Multiplexing Passive Optical Network, WDM-PON.

FIG. 5 illustrates an exemplifying embodiment of a media converter 509 comprising two ports 502, 503. The media converter 509 communicates employing flow control with an L2 switch 508 and communicates to an Optical Physical Media Dependent, PMD, device employing a variable transmission rate. The variable transmission rate corresponds to the negotiated transmission rate described above.

According to an example, when the two end terminals have negotiated a transmission rate to be employed for executing communication in one direction, e.g. from the first end terminal to the second end terminal, and a transmission rate to be employed for executing communication in the other direction, from the second end terminal to the first end terminal, these negotiated transmission rates are dynamic. A reason to change to transmission rate in either direction is that conditions on the link have changed or that it is detected that the communication between the two end terminals is not satisfactory. An example of a reason to start re-negotiating the transmission rate is that at least one of the end terminals receives an alarm signal, such as “loss of signal”, “link up”, “link down”, “low bit error ratio” and “high bit error ratio”. A further example of a reason to start re-negotiating the transmission rate is that at least one of the end terminals receives statistical information from an FEC decoder block. Still a further exemplifying reason to change to transmission rate in either direction is that at least one end terminal receives a command from a control plane.

According to still an embodiment, the negotiation procedure makes use of pre-known characteristics of the optical fibre link to speed up the negotiation process. An example of such pre-known characteristics is a previously detected fault on the fibre link such that the fibre link is only capable of supporting communication executed with a relatively low transmission rate. In this embodiment, when sending the first transmission test message, the highest transmission rate with which the first transmission test message is sent, is the relatively low transmission rate currently being supported on the fibre link in question, as opposed to the highest transmission rate with which the end terminal is capable of using when executing communication to another end terminal.

The purpose of the transmission test is to determine the transmission quality of the link (typically measured in terms of bit error ratio). When conducting the transmission test, there is a trade-off between test time and accuracy. The level of accuracy needed depends on the specific application scenario. The bit pattern in the “transmission test” message should be carefully chosen to give the best accuracy of the test. According to an embodiment, the bit pattern is generated from a pseudo-random bit sequence such as Pseudo Random Bit Sequence, PRBS-7, PRBS-15 or PRBS-31.

In an example where higher accuracy is needed, the receiver counts the received number of bits with the number of bit errors to estimate the bit error ratio. In another example where low accuracy is enough, the transmission test message contains a specific test pattern plus a Cyclic Redundancy Check, CRC, checksum. The receiver can then calculate the checksum from the received bit pattern and match with the received checksum, to detect if a bit error has occurred.

In still an example, the transmission quality of the link is determined by measuring the received optical power at the receiver.

As was described above, the transmission rate used to execute communication in one direction does not have to be the same as the transmission rate used to execute communication in the other or opposite direction. As an example, the downstream rate from a first end terminal is 1 Gbit/s and the upstream rate to the first end terminal is 500 Mbit/s. This could either be because transmission takes place at different wavelengths or because of different capabilities in the end terminals (e.g. for cost reasons).

It was described above that the method is initiated, in an exemplifying embodiment, as a result of the detection of a link failure during an ongoing communication between the first and the second end terminal. The detection of the link failure can be done by one of the end terminals or both end terminals. A case when only one end terminal detects a failure (e.g. “loss of signal” or “high bit error ratio”) and the two end terminals use different transmission rates in “uplink” and “downlink” will now be described. One definition of downlink is communication from an OLT to an ONU, and consequently uplink is communication from an ONU to an OLT. In this example, the optical fibre link is damaged resulting in an added loss over the fibre link. The communication over the fibre link between the two end terminals (an ONU and an OLT) may take place at different wavelengths in upstream and downstream direction. Consequently, this added loss may degrade the communication differently in each direction. In this example, there is a risk that only one end terminal will enter the link setup negotiation or transmission rate negotiation and link recovery will fail. Further in this example, to overcome this problem the transmitter is turned off, at least for a minimum duration, at the end terminal that detects a failure. This will provoke a “loss of signal” alarm in the other end terminal and thus both ends can enter the negotiation procedure.

In yet an embodiment, data traffic is blocked when transmission rate negotiation takes place. In another embodiment, to allow for transmission rate negotiation to take place at the same time as the link carries traffic, a separate channel for transmission rate negotiation is used. This separate channel has relatively low bandwidth requirements, which allows for many different solutions. In an example, Frequency Division Multiplexing, FDM, or Wavelength Division Multiplexing, WDM is used. In another example the main channel is modulated using low frequency Amplitude Modulation, AM. In still another example, gaps in the data stream of the main channel are used: as an example, over an Ethernet link, the inter-packet gap (IPG) is filled with negotiation messages.

According to an embodiment, a communication protocol is provided between the end terminals for exchanging messages during negotiation. In one example, the ONU management and control interface OMCI as defined in ITU-T G.988 is used as a base. In another example, when the protocol used for data transfer over the link is Ethernet, Ethernet Operation Administration and Maintenance, OAM, messages are used, as described in IEEE 802.3 clause 57. In still another example, a specific protocol is used, which runs only during negotiation and optionally also synchronisation. In yet another example, a control plane configures the end terminals.

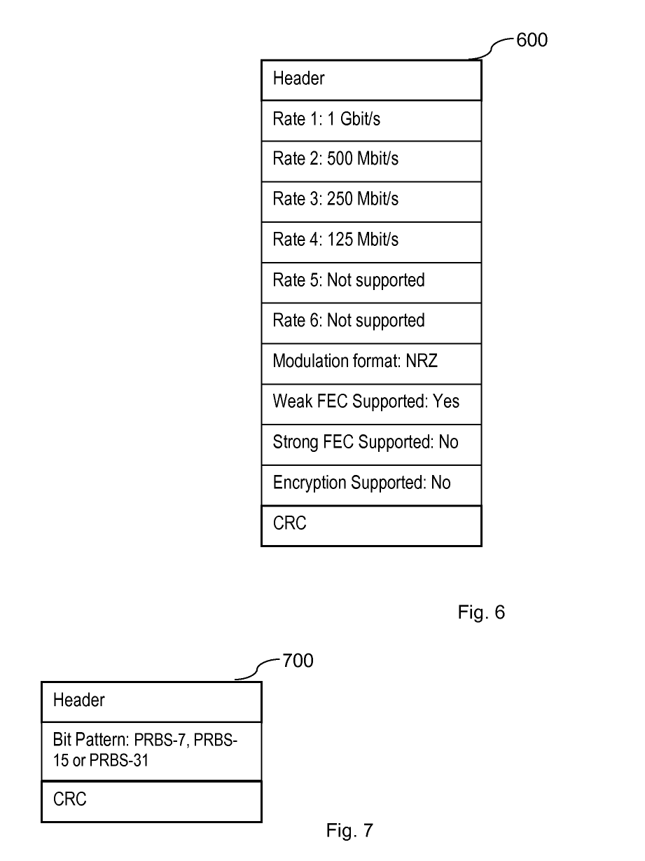

FIG. 6 is a block diagram schematically illustrating an exemplifying information message. In FIG. 6, it is illustrated that an information message 600 according to this example comprises a header and then it is indicated which transmission rates are supported by the end terminal that will send this information message. In this example, 6 predefined transmission rates are possible in the passive optical network system, and the end terminal sending this information messages indicates which transmission rates it supports, here rates 1, 2, 3 and 4 are supported, whereas rates 5 and 6 are not supported. Further, the end terminal indicates in the information message which modulation format it supports, if it supports strong and/or weak FEC and if the end terminal supports encryption. Further in this example, a CRC checksum is comprised in the information message. This enables the receiving end terminal to determine if the information message was correctly received.

FIG. 7 is a block diagram schematically illustrating an exemplifying transmission test message. The transmission test message is sent from one end terminal to another end terminal at a specific transmission rate as has been previously described. In this example, the transmission test message comprises a known bit pattern. The known bit pattern is known by both end terminals. The receiving end terminal will compare the received bit pattern to the known bit pattern to detect if any errors have occurred in the bit pattern when sent over the fibre link.

In the described embodiments, forward error correction (FEC) may optionally be used. While finding the maximum transmission rate over a specific link, FEC can help to give additional link budget. An example of such code is the Reed-Solomon (255,239) code which gives a bandwidth overhead of roughly 7% and may increase the link budget by 3-5 dB. There are multiple FEC codes that can be used. For example, two different FEC codes could be supported; one referred to as strong FEC (giving higher link budget increase at the cost of higher bandwidth overhead), and one referred to as weak FEC (giving lower link budget increase at the cost of lower bandwidth overhead). When the end terminals negotiate which transmission rate to use over a link, according to an embodiment, several other parameters may be negotiated, both with regard to communication to the other end terminal and also with regard to communication received from the other end terminal.

According to an embodiment, the further parameters comprise any of Forward Error Correction, FEC, cryptographic capabilities and usage, modulation format and parameters and also whether to use FEC or not, and also which FEC code to use.

According to yet an embodiment, in case that the negotiated transmission rate is lower than the highest possible rate, the source side switching equipment is configured to prioritize traffic and selectively discard traffic that exceeds the capacity of the link. In an example, the prioritisation of traffic is performed in a manner so that service level agreements (SLA) and quality-of-service (QoS) guarantees are met.

It should be noted that FIG. 3 merely illustrates various functional modules and units in the first end terminal and the second end terminal in a logical sense. The functions in practice may be implemented using any suitable software and hardware means/circuits etc. Thus, the embodiments are generally not limited to the shown structures of the first end terminal and the second end terminal and the functional modules and units. Hence, the previously described exemplary embodiments may be realised in many ways. For example, one embodiment includes a computer-readable medium having instructions stored thereon that are executable by the respective processing units in the first end terminal and the second end terminal for executing the method as set forth in the claims. The instructions executable by the computing system and stored on the computer- readable medium perform the method steps of the exemplifying embodiments as set forth in the claims.

While the embodiments have been described in terms of several embodiments, it is contemplated that alternatives, modifications, permutations and equivalents thereof will become apparent upon reading of the specifications and study of the drawings. It is therefore intended that the following appended claims include such alternatives, modifications, permutations and equivalents as falling within the scope of the embodiments and defined by the pending claims.

1-40. (canceled)

41. A method in a first end terminal for enabling communication between said first end terminal and a second end terminal in a fiber optic access network, wherein the method is performed in an arrangement in the first end terminal, the method comprising:
initiating a synchronization procedure with the second end terminal for synchronizing the first and second end terminals with each other and enabling them to start a negotiation procedure, wherein initiating the synchronization procedure comprises:
setting the transmission rate to a lowest value;
sending an information message to the second end terminal, the information message comprising information pertaining to transmission rate capabilities of the first end terminal, the information message being sent at the lowest transmission rate; and
starting a first preset timer, wherein if the first preset timer expires before an acknowledgement message is received from the second end terminal, then generating a link failure message and ending the synchronization procedure; and
when the synchronization procedure is successful, then:
performing said negotiation procedure with the second end terminal, the negotiation procedure pertaining to a transmission rate for communication on the fiber link between the first and second end terminals; and
executing communication to the second end terminal employing said negotiated transmission rate.

42. The method according to claim 41, wherein initiating the synchronization procedure further comprises, before the expiration of the first preset timer:
receiving an acknowledgement message from the second end terminal before the first preset timer expires; and
receiving a second information message from the second end terminal, the second information message comprising information pertaining to transmission rate capabilities of the second end terminal, thereby synchronizing the first and second end terminals with each other and enabling them to start the negotiation procedure.

43. The method according to claim 41, wherein initiating the synchronization procedure further comprises, before the expiration of the first preset timer:
receiving the acknowledgement message from the second end terminal before said first preset timer expires, the acknowledgement message comprising information pertaining to transmission rate capabilities of the second end terminal, the acknowledgement message being received at the lowest transmission rate thereby synchronizing the first and second end terminals with each other and enabling them to start the negotiation procedure.

44. The method according to claim 41, wherein performing the negotiation procedure comprises:
setting the transmission rate to a highest value;
sending a first transmission test message to the second end terminal at the transmission rate set to the highest value;
starting a second preset timer; and
receiving a first test reply message from the second end terminal before the second preset timer expires confirming reception of the first transmission test message sent at the transmission rate set to the highest value and using the transmission rate set to the highest value for executing communication to the second end terminal; or
if the second preset timer expires before the first test reply message is received:
reducing the transmission rate and sending a second transmission test message to the second end terminal at the reduced transmission rate; and
restarting the second preset timer.

45. The method according to claim 44, further comprising:
if the second preset timer expires before a second test reply message is received, further reducing the transmission rate and sending a further transmission test message to the second end terminal at the further reduced transmission rate, and restarting the second preset timer; or
if the second test reply message is received from the second end terminal before the second preset timer expires confirming reception of the transmission test message sent at the reduced transmission rate, using the reduced transmission rate for executing communication to the second end terminal.

46. The method according to claim 45, further comprising repeating the steps of claim 45 until:
a test reply message is received from the second end terminal before expiration of the second preset timer confirming reception of a transmission test message sent at a specific reduced transmission rate, wherein the specific transmission rate will be used for executing communication to the second end terminal; or
the transmission test message has been sent to the second end terminal using the lowest transmission rate and the second preset timer set for this transmission has expired, wherein a link failure message is generated and the negotiation procedure ends.

47. The method according to claim 41, further comprising:
receiving a third transmission test message at a specific transmission rate from the second end terminal; and
sending a third test reply message to the second end terminal confirming reception of the third transmission test message, thereby confirming to the second end terminal the specific transmission rate with which the third transmission test message was received.

48. The method according to claim 41, further comprising negotiating, with the second end terminal, one or more further parameters to be used for communication on the link from the first end terminal to the second end terminal.

49. The method according to claim 48, wherein the further parameters comprise at least one of Forward Error Correction (FEC), cryptographic capabilities and usage, and modulation format and parameters.

50. The method according to claim 41, wherein the method is performed at link setup between the first and the second end terminals.

51. The method according to claim 41, wherein the method is performed in response to the first end terminal detecting a link failure during an ongoing communication between the first and the second end terminals.

52. A method in a second end terminal for enabling communication between the second end terminal and a first end terminal in a fiber optic access network, wherein the method is performed in an arrangement in the second end terminal, the method comprising:
receiving an information message from the first end terminal, the information message comprising information pertaining to transmission rate capabilities of the first end terminal; and
acknowledging said information message and sending information pertaining to transmission rate capabilities of the second end terminal to the first end terminal, thereby synchronizing the first and second end terminals with each other and enabling them to start negotiation of the transmission rate to be employed for communication on a fiber link between the first and second end terminals;
wherein acknowledging said information message and sending information pertaining to the transmission rate capabilities of the second end terminal to the first end terminal comprises:
sending one acknowledgement message comprising said information pertaining to the transmission rate capabilities of the second end terminal; or
sending a separate acknowledgement message and a separate reply information message comprising information pertaining to the transmission rate capabilities of the second end terminal.

53. The method according to claim 52, further comprising:
receiving successfully a first transmission test message from the first end terminal at a transmission rate;
sending a first test reply message to the first end terminal confirming the reception of the first transmission test message at the transmission rate; and
receiving communication from the first end terminal at the transmission rate.

54. The method according to claim 53, further comprising:
setting the transmission rate to a highest value;
sending a second transmission test message to the first end terminal at the transmission rate set to the highest value;
starting a preset timer; and
receiving a second test reply message from the first end terminal before the preset timer expires confirming reception of the second transmission test message sent at the transmission rate set to the highest value and using the transmission rate set to the highest value for executing communication to the first end terminal; or
if the preset timer has expired before the second test reply message is received, reducing the transmission rate and sending a third transmission test message to the first end terminal at the reduced transmission rate, and restarting the preset timer.

55. The method according to claim 54, further comprising:
if the preset timer expires before a third test reply message is received, further reducing the transmission rate and sending a further transmission test message to the first end terminal at the further reduced transmission rate, and restarting the preset timer; or
if the third test reply message is received from the first end terminal before expiration of the preset timer confirming reception of the third transmission test message sent at the reduced transmission rate, using the reduced transmission rate for executing communication to the first end terminal.

56. The method according to claim 55, further comprising repeating the steps of claim 55 until:
a test reply message is received from the first end terminal before expiration of the preset timer confirming reception of a transmission test message sent at a specific reduced transmission rate, wherein the specific reduced transmission rate will be used for executing communication to the first end terminal; or
the transmission test message has been sent to the first end terminal using the lowest transmission rate and the preset timer for this transmission has expired, wherein a link failure message is generated and the method ends.

57. The method according to claim 52, further comprising negotiating, with the first end terminal, one or more further parameters to be used for communication on the link from the second end terminal to the first end terminal.

58. The method according to claim 57, wherein the further parameters comprise at least one of Forward Error Correction (FEC), cryptographic capabilities and usage, and modulation format and parameters.

59. The method according to claim 52, wherein the method is performed at link setup between the second and the first end terminals.

60. The method according to claim 52, wherein the method is performed in response to the first end terminal detecting a link failure during an ongoing communication between the second and the first end terminals.

61. An arrangement in a first end terminal in a fiber optic access network adapted to enable communication between the first end terminal and a second end terminal, the arrangement comprising:
a first preset timer; and
a processing circuit configured to:
initiate a synchronization procedure with the second end terminal for synchronizing the first and second end terminals with each other and enabling them to start a negotiation procedure by:
setting the transmission rate to a lowest value;
sending an information message to the second end terminal, the information message comprising information pertaining to transmission rate capabilities of the first end terminal, the message being sent at the transmission rate set to the lowest value; and
starting the first preset timer, wherein if the first preset timer expires before an acknowledgement message is received from the second end terminal, then the processing circuit is further configured to generate a link failure message;
when the synchronization procedure is successful, then the processing circuit is further configured to:
perform said negotiation procedure with the second end terminal, the negotiation procedure pertaining to a transmission rate for communication on the fiber link between the first and second end terminals; and
execute communication to the second end terminal employing said negotiated transmission rate.

62. The arrangement in the first end terminal according to claim 61, wherein the processing circuit is further configured to:
before the expiration of the first preset timer:
receive an acknowledgement message from the second end terminal before the first preset timer expires; and
receive a second information message from the second end terminal, the second information message comprising information pertaining to transmission rate capabilities of the second end terminal, thereby synchronizing the first and second end terminals with each other and enabling them to start the negotiation of the transmission rate.

63. The arrangement in the first end terminal according to claim 61, wherein the processing circuit is further configured to:
before the expiration of the first preset timer, receive an acknowledgement message from the second end terminal, the acknowledgement message comprising information pertaining to transmission rate capabilities of the second end terminal, thereby synchronizing the first and second end terminals with each other and enabling them to start the negotiation of the transmission rate; or
if the first preset timer expires before the acknowledgement message is received from the second end terminal, generate a link failure message.

64. The arrangement in the first end terminal according to claim 61, further comprising a second preset timer, wherein the processing circuit is further configured to:
set the transmission rate to a highest value;
send a first transmission test message to the second end terminal at the transmission rate set to the highest value;
start the second preset timer; and
receive a first test reply message from the second end terminal before the second preset timer expires confirming reception of the first transmission test message sent at the transmission rate set to the highest value and use the transmission rate set to the highest value for executing communication to the second end terminal; or
if the second preset timer has expired before the first test reply message is received, reduce the transmission rate and send a second transmission test message to the second end terminal at the reduced transmission rate, and restart the second preset timer.

65. The arrangement in the first end terminal according to claim 64, wherein the processing circuit is further configured to:
if the second preset timer expires before a second test reply message is received, further reduce the transmission rate and send a further transmission test message to the second end terminal at the further reduced transmission rate, and restart the second preset timer; or
if the second test reply message is received from the second end terminal before the second preset timer expires, confirm reception of the transmission test message sent at the reduced transmission rate, and use the reduced transmission rate for executing communication to the second end terminal.

66. The arrangement in the first end terminal according to claim 65, wherein the processing circuit is further configured to repeat the steps of claim 65, until:
a test reply message is received from the second end terminal before expiration of the second preset timer confirming reception of a transmission test message sent at a specific reduced transmission rate, wherein the processing circuit is configured to use the specific transmission rate for executing communication to the second end terminal; or
the transmission test message has been sent to the second end terminal using the lowest transmission rate and the second preset timer set for this transmission has expired, wherein the processing circuit is configured to generate a link failure message.

67. The arrangement in the first end terminal according to claim 61, wherein the processing circuit is further configured to:
receive a third transmission test message at a specific transmission rate from the second end terminal; and
send a third test reply message to the second end terminal confirming reception of the third transmission test message, thereby confirming to the second end terminal the specific transmission rate with which the third transmission test message was received.

68. The arrangement in the first end terminal according to claim 61, wherein the processing circuit is further configured to negotiate, with the second end terminal, one or more further parameters to be used for communication on the link from the first end terminal to the second end terminal.

69. The arrangement in the first end terminal according to claim 68, wherein the further parameters comprise at least one of Forward Error Correction (FEC), cryptographic capabilities and usage, and modulation format and parameters.

70. The arrangement in the first end terminal according to claim 61, wherein the processing circuit is configured to perform the steps at link setup between the first and the second end terminals.

71. The arrangement in the first end terminal according to claim 61, wherein the processing circuit is configured to perform the steps in response to the first end terminal detecting a link failure during an ongoing communication between the first and the second end terminals.

72. An arrangement in a second end terminal in a fiber optic access network adapted to enable communication between the second end terminal and a first end terminal, the arrangement comprising a processing circuit configured to:
receive an information message from the first end terminal, the information message comprising information pertaining to transmission rate capabilities of the first end terminal; and
acknowledge said information message and send information pertaining to transmission rate capabilities of the second end terminal to the first end terminal, thereby synchronizing the two terminals with each other and enabling them to start negotiation of the transmission rate to be employed for communication on a fiber link between the second end terminal and first end terminal;
wherein the processing circuit is configured to acknowledge said information message and to send information pertaining to transmission rate capabilities of the second end terminal by:
sending one acknowledgement message comprising said information pertaining to the transmission rate capabilities of the second end terminal; or
sending a separate acknowledgement message and a separate information message comprising information pertaining to the transmission rate capabilities of the second end terminal.

73. The arrangement in the second end terminal according to claim 72, wherein the processing circuit is further configured to:
receive successfully a first transmission test message from the first end terminal at a transmission rate;
send a first test reply message to the first end terminal confirming the reception of the first transmission test message at the transmission rate; and
receive communication from the first end terminal at the transmission rate.

74. The arrangement in the second end terminal according to claim 73, further comprising a preset timer, wherein the processing circuit is further configured to:
set the transmission rate to a highest value;
send a second transmission test message to the first end terminal at the transmission rate set to the highest value;
start the preset timer;
receive a second test reply message from the first end terminal before the preset timer expires confirming reception of the second transmission test message sent at the transmission rate set to the highest value and use the transmission rate set to the highest value for executing communication to the first end terminal; or
if the preset timer has expired before the second test reply message is received, reduce the transmission rate and send a third transmission test message to the first end terminal at the reduced transmission rate, and restart the preset timer.

75. The arrangement in the second end terminal according to claim 74, wherein the processing circuit is further configured to:
if the preset timer expires before a third test reply message is received, further reduce the transmission rate and to send a further transmission test message to the first end terminal at the further reduced transmission rate, and restart the preset timer; or
if the third test reply message is received from the first end terminal before expiration of the preset timer confirming reception of the third transmission test message sent at the reduced transmission rate, use the reduced transmission rate for executing communication to the first end terminal.

76. The arrangement in the second end terminal according to claim 75, wherein the processing circuit is further configured to repeat the steps of claim 75 until:
a test reply message is received from the first end terminal before expiration of the preset timer confirming reception of a transmission test message sent at a specific reduced transmission rate, wherein the processing circuit is configured to use the specific transmission rate for executing communication to the first end terminal; or
the transmission test message has been sent to the first end terminal using the lowest transmission rate and the preset timer set for this transmission has expired, wherein the processing circuit is configured to generate a link failure message.

77. The arrangement in the second end terminal according to claim 72, wherein the processing circuit is further configured to negotiate, with the first end terminal, one or more further parameters to be used for communication on the link from the second end terminal to the first end terminal.

78. The arrangement in the second end terminal according to claim 77, wherein the further parameters comprise at least one of Forward Error Correction (FEC), cryptographic capabilities and usage, and modulation format and parameters.

79. The arrangement in the second end terminal according to claim 72, wherein the processing circuit is further configured to perform the steps at link setup between the second end terminal and the first end terminal.

80. The arrangement in the second end terminal according to claim 72, wherein the processing circuit is further configured to perform the steps in response to the first end terminal detecting a link failure during an ongoing communication between the second end terminal and the first end terminal.
